(19) United States
(12) Patent Application Publication
(10) Pub. No.: US 2007/0251637 A1
(43) Pub. Date: Nov. 1, 2007

(54) Locally bonding multi-layer arrays

(76) Inventors: James Barss, Porter Corners, NY (US); Jason Beach, Ballston Lake, NY (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/411,297

(22) Filed: Apr. 26, 2006

(51) Int. Cl. B32B 37/00

(52) U.S. Cl. 156/272.2

(57) ABSTRACT

In the methods described, a treatment method is employed on a flexible substrate forming a multi-layer array. The method includes providing the flexible substrate; placing a material to be treated on a surface of the flexible substrate; and treating the material with a frequency energy.

### TECHNICAL FIELD

Described herein is a method for treating material, more particularly, for treating multi-layer arrays.

### BACKGROUND

One type of multi-layer array is an expandable honeycomb insulation panel or cellular window array made from a plurality of strips or folded stacked sheets of flexible fabric or film and bonded between adjacent layers along parallel lines to form an expandable cellular structure.

The fabrication of expandable honeycomb insulation panels entails a continuous process of manipulating a continuous length of thin plastic film to form uniform, clean-cut, neat, and effective insulation panels. This includes the steps of continuously creasing and folding the thin plastic film into an open-sided tubular structure, heat-setting the folds against a surface and under constant tension in a uniform manner to eliminate internal stresses that could otherwise cause warps or wrinkles, applying continuous adhesive material to the surface of the open sided tubular structure, and continuously stacking the tubular film in layers on a flat surface or a plurality of flat surfaces to eliminate any curves that might cause wrinkles or warps in the finished product.

An apparatus for fabricating the expandable honeycomb insulation material described above includes an initial creaser assembly in which a pair of spaced-apart sharp wheels are pressed into the film to form uniformed creases in the film material. It also includes a folding assembly to fold the lateral edges at the crease over the mid-portion thereof, and a press assembly to mechanically crimp the folds. The apparatus also includes a heat-setting assembly for heating the plastic film material to a sufficiently high temperature so that it loses its elasticity and becomes sufficiently plastic to permanently set the folds therein. This heat-setting assembly provides a uniform surface around the periphery of a large-diameter heated roller on which the folded film is pressed under constant tension to eliminate internal stresses in the material.

A drive assembly pulls the plastic film through the folding and heat-setting assemblies, and a positive displacement pump feeds a liquid adhesive through an applicator for deposition onto the surface of the folded tubular plastic film. The pump is driven from the film drive assembly so that the rate of deposition of the adhesive material on the film is always in direct relation to the rate of speed in which the film moves through the apparatus in order to maintain uniform beads of adhesive for glue lines in the finished panel product. The apparatus also includes a rotatable stacking bed with flat surfaces on which successive lengths of tubular film are stacked in uniform layers, one on another, where they are adhered together to form the panel structures, and a tension and speed control assembly for maintaining a constant tension of the film as it is stacked uniformly in layers on the rotating stacking bed.

This process is time-consuming and expensive requiring application of adhesive lines before stacking, followed by bulk treatment of the stack to activate and cure the adhesive. While faster than prior art methods, this process requires containment of large stacks of material for curing, done thermally by heating the entire stack and its containment. Specifically, this step consumes excessive energy and time, and includes a risk of thermal distortion in the heating of the stack. Therefore, there is a need for a faster, less thermally intense method of curing pre-applied adhesives within the stack. Such a method is broadly applicable to numerous layered products, such as quilts, carpets, insulation goods, heat exchangers, and the like where complex patterns of bonding are required within the bulk of a built-up assemblage of layers.

### SUMMARY

As described below, a treatment method is employed on a flexible substrate forming a multi-layer array. The method includes providing the flexible substrate; placing a material to be treated on a surface of the flexible substrate; and treating the material with a frequency energy.

### BRIEF DESCRIPTION OF THE DRAWINGS

The features and inventive aspects of the present invention will become more apparent from the following detailed description, the appended claims, and the accompanying drawings, of which the following is a brief description:

FIG. 1 is a cross-sectional illustration of an exemplary embodiment of a folded multi-layer array showing enlarged circular bonding lines for clarity;

FIG. 2 is a cross-sectional illustration of the array of FIG. 1 in an expanded orientation showing enlarged circular bonding lines for clarity;

FIG. 3 is a perspective view of a material forming the array of FIG. 1, showing a pattern of coatings;

FIG. 4 is a side elevation of the material of FIG. 3 showing the pattern of coatings in greater detail;

FIG. 5 is an exemplary schematic of a machinery layout;

FIG. 6 is an end elevational view, partially sectional, of a roller-type pleater employed in the machinery layout of FIG. 5;

FIG. 7 is a sectional schematic representation of a folding station employed in the machinery of layout of FIG. 5; and

FIG. 8 is a schematic representation of a radio-frequency press.

### DETAILED DESCRIPTION

Referring now to the drawings, illustrative embodiments are shown in detail. Although the drawings represent the embodiments, the drawings are not necessarily to scale and certain features may be exaggerated to better illustrate and explain an innovative aspect of an embodiment. Further, the embodiments described herein are not intended to be exhaustive or otherwise limit or restrict the invention to the precise form and configuration shown in the drawings and disclosed in the following detailed description.

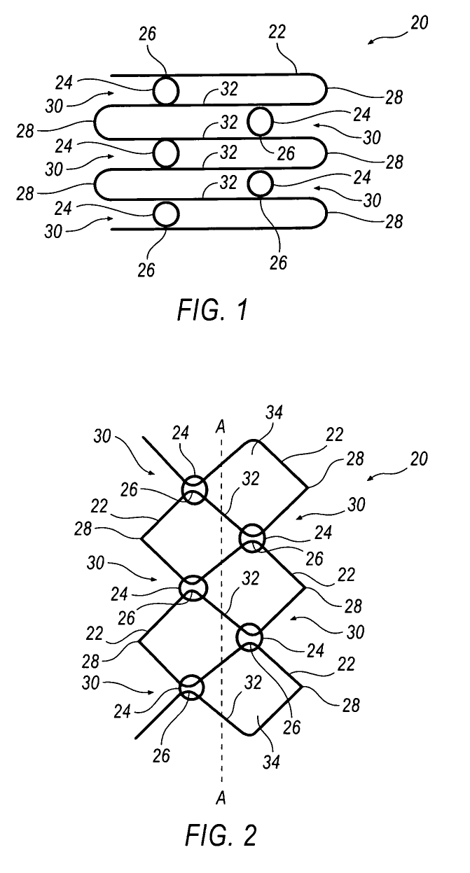

Referring now to FIGS. 1 and 2, an exemplary embodiment of a cellular array 20 (also referred to as a cellular shade) is illustrated in a collapsed and expanded position. For the purposes of lending brevity and clarity to the disclosure, FIGS. 1 and 2 are illustrated having a material forming ligaments between bonding lines 24 in the structure of the cellular array 20. It should be understood that the bonding lines 24 are typically a thin film between the material folds forming the ligaments 22. However, for the purpose of clarity, the bonding lines 24 are represented as circular in form. The ligaments 22 may be any portion of the cellular array 20, folded or unfolded. Specifically, the ligaments 22 are parts of the cellular array 20 appearing between bonding lines 24 and folds 28. A bonding line 24 includes any portion of the cellular array 20 that has glue or adhesive, whether fully or partially cured, applied thereto. The bond line 24 results when an adhesive adheres to another adhesive or any other portion of the cellular array 20. The term “line” is used simply because, to the untrained eye, the adhesive appears to be nothing more than a (barely) discernible line of a coating material. But, it is the character of appropriate adhesives to stiffen when fully cured and thereby impart to the cellular array 20 an integral, transverse structural element.

The cellular array 20 is formed from a continuous material having an adhesive applied between each predetermined index 26 for a fold 28, generally closer to the open side 30 of the proposed fold 28 than to the closed side proximate the fold 28. In appearance, the bonding line 24 straddles a crease or fold 28. Each bonding line 24 is generally equidistant from the fold 28 and on the surface of the cellular array 20 that will be exposed to view.

In FIG. 2, the flexibility of the cellular array 20 material and the functioning of folds 28 as permanent hinge lines permit the tubular ligaments 22 to be readily and non-destructively collapsed and expanded along an axis A-A parallel to the length of the original cellular array 20 as the cellular array 20 is raised and lowered, respectively, during use. The ligaments 22 are parts of the cellular array 20 appearing between bonding lines 24 and folds 28; and internal ligaments 32 are portions of the cellular array 20 appearing between the bonding lines 24. When the resulting structure is expanded, as in FIG. 2, a continuous array of enclosed tubular cells is formed. If the bonding lines 24 are located such that the ligaments 22 are generally shorter than the internal ligaments 32, then the cellular array 20 will reach its full extension with the ligaments 22 approaching a generally parallel relationship with one another, without excessive twisting of internal ligaments 32. The outer faces; that is, the back and front of the cellular array 20, are for all intents and purposes generally identical. The viewer observes only a pleated array, aesthetically pleasing to the eye.

The exemplary embodiment illustrated in FIGS. 1 and 2 permits the inclusion of actuating and guiding mechanisms (not shown) in the space between the bonding lines 24. The internal ligaments 32 may be pierced, slotted, or truncated (that is, the transverse length of the internal ligaments 32, relative to the ligaments 22, is shortened) in order to provide for any of known actuating and guiding mechanisms, without danger of binding the mechanisms.

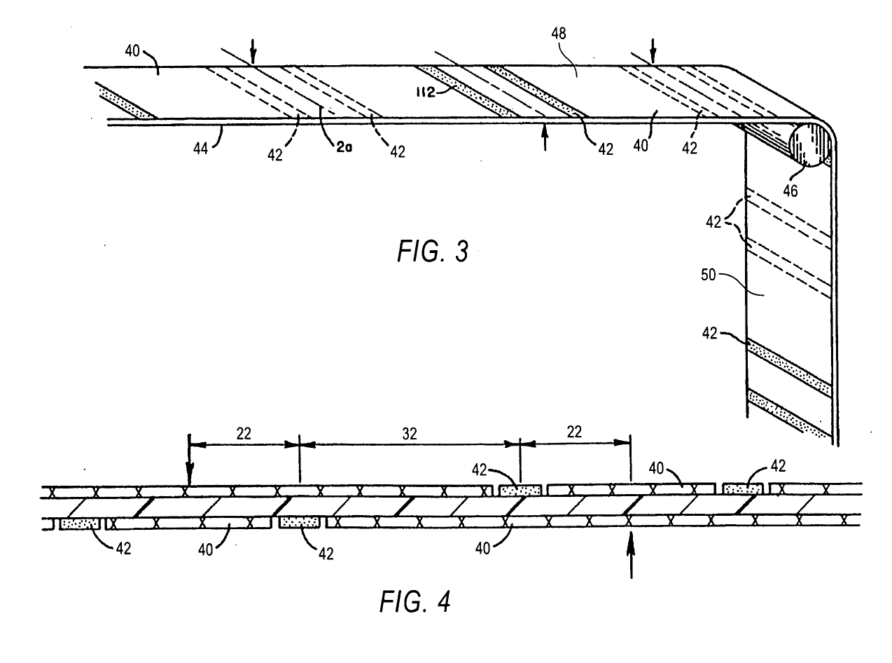

For purposes of illustration, FIG. 3 is highly stylized in that the material 40 forming the cellular array 20 is shown with an imprinted pattern of coatings, and the adhesive bonding lines 24 are denoted by strips 42. The material 40 passes over a roller 46 and is displayed narrower than it would actually be. The material 40 is printed on an upper surface 48 and a lower surface 50 and the adhesive strips 42 that appear in FIG. 3 are alternatingly placed with adhesive strips 42 that appear on the lower surface 50.

FIG. 4 is a side elevation of the material 40 and presents the coating scheme of FIG. 3 in cross-section. The large barbed arrowheads denote the points of fold as they appear in their alternating pattern. As the material 40 is folded, in the direction of the bold arrowhead, the ligaments 22, as indicated herein, become the webbing portions that are located between the folds 28 and its adjacent strips 42 of FIG. 2. Discernible in FIG. 4 is the resulting internal ligament 32, and the webbing between adjacent adhesive strips, herein 42. This coating and folding pattern realizes the structure disclosed in FIGS. 1 and 2.

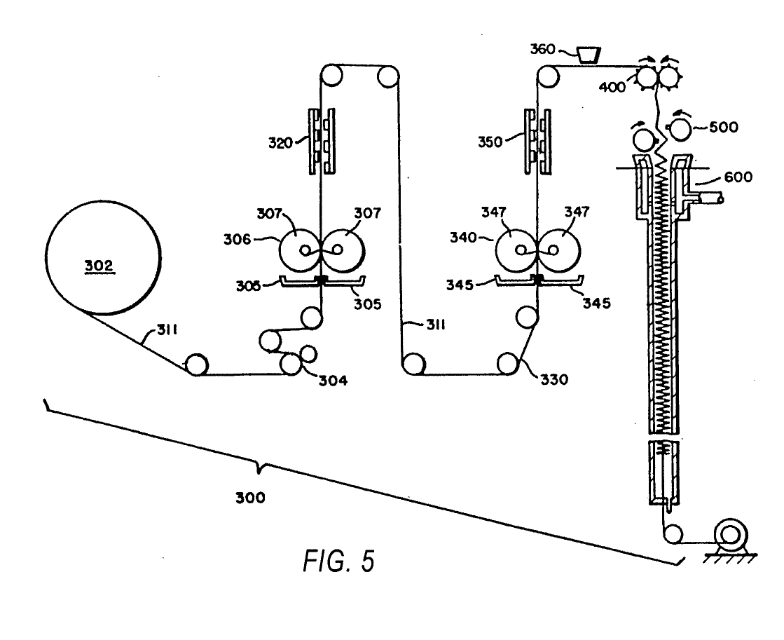

The manufacture of the exemplary embodiments of the cellular array 20 is accomplished through an amalgamation of techniques and machinery such as screen printers, phasing control electronics, and adhesive curing apparatus. Tying all of the apparatus together to realize the described embodiment is an exemplary process that begins with a single continuous material 40 as described above, (fabric web 311 and folded fabric web 311′ for the purpose of the manufacturing description) and results in a completed product that is only then separated from the continuous web 311 for final curing. Illustrative of the machinery and process used to acquire the described embodiment is FIG. 5, a schematic drawing of the production line 300. The process begins with an unrolling of the web 311 from the supply reel 302. The web 311 is passed through a tensioner station 304, the function of which is to maintain proper tautness in the web 311 throughout the first process to be performed thereon.

After passing through the tensioner 304 the web 311 passes through the first screen printing station 306, between the drip trays 305 and the print rollers 307 thereof. The screen printer, like the source roller and tensioner 304, includes existing machinery and has as its primary function the ability to print and/or coat the web 311, both top and bottom, with various desired colors, patterns or coatings, of adhesive. These other coatings, addressed in FIGS. 3 and 4, may include colorings, texturings or myriad forms of reflective or insulative coatings.

In keeping with the type of coatings thus applied at the first screen printing station 306, the next station to be encountered by the newly coated web 311 is the first curing station 320. This station renders a full curing to the coatings previously applied, i.e. to fully “dry” the coatings and thereby reduce porosity of the web 311. At this point, the web 311 has been coated, on both sides, with preselected coatings at predetermined locations. It should be noted that multiple stations that apply coatings to only one side per station, but are otherwise similar to the two-sided coaters described herein may be used if desired.

Passing out of the first drying station, the web 311 moves to a registry detection station 330, the function of which is to provide final adjustment in the web 311 travel so that the uncoated spaces, both top and bottom, will be properly aligned for deposition of the adhesive or bonding material.

Immediately thereafter, the web 311 is passed into the second screen printing station 340 where, like at the first, it passes between drip trays 345 and screen printing rollers 347 to be coated with the predetermined bonding line scheme.

Subsequently, the web 311, bearing adhesive applications on both sides, is passed into the second curing station 350. This station differs from the first in that only a partial cure is effected. Where, at the first curing station a full cure is desired in order to dry the color, reflective and insulative coatings, now only a partial curing to the “gel” state is made. The adhesive remains in a partially cured state until it can be brought into contact with another section of the same web 311 to effect the bond lines.

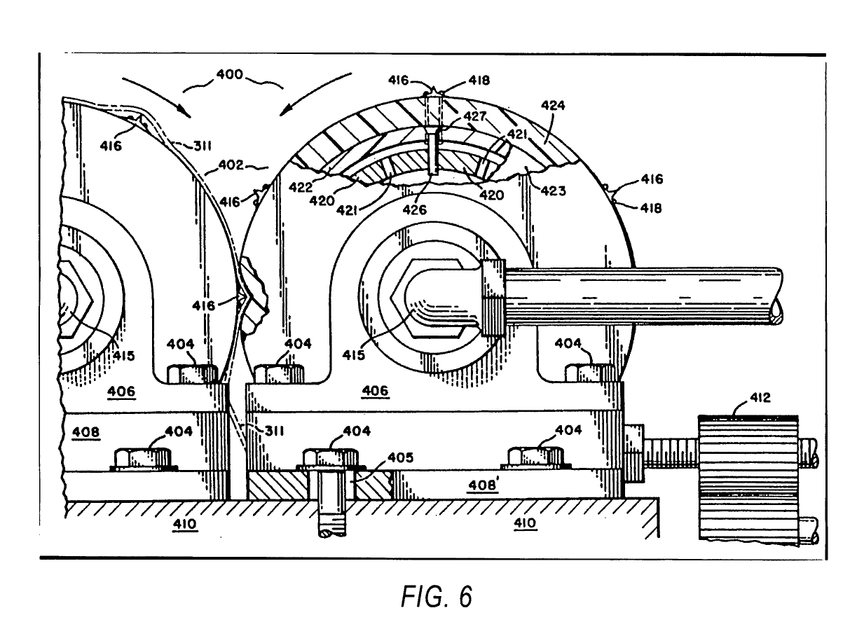

After leaving the last curing station 350, the web 311 is passed downline to the creaser 400. Immediately before its encounter with the creaser 400, the web 311 is subjected to final scrutiny by passing it over the phase reader 360. The reader operates with creaser 400, causing the diameters of rollers 402 of FIG. 6 to vary, thus controlling the pitch of the pleats and the phase of the pleats relative to the print pattern.

After proper phasing relationship is established relative to the adhesive strip (print) placement, the web 311 is introduced to the creaser 400. There, creases or folds are made in the web 311, in alternating pattern(s) after the fashions described above and in FIGS. 3 and 4.

Upon exiting the creaser 400, the alternatingly creased web 311 is passed to the folding machinery 500, 600. The first portion of the folding machinery includes a pair of counter-rotating air knives fixed in set-apart registry and receptive of the creased web 311 between them. The air knife, a device well known in several industries, includes a machine capable of emitting a steady, intense flow of air along a predetermined path. In this instance, both air knives emit this intense flow of air in a straight line, transverse of the web 311. Since the knives are spaced one from the other and rotate in opposite directions, there is effected between them a shearing wind pattern. As the web 311 passes between the rotating air knives, its presence forms a barrier and, if the rotation and counter-rotation of the air knives 500 are properly phased, the shearing effect of the radially moving planes of air will cause a fold at the creases of the web 311 by intensifying the folds at their troughs. Continuing in the pattern of rotation, the air knives urge the trough (which each respectively fills) towards the direction of movement of web 311.

The urging of the folding web 311 is such that it is readily introduced into the second substation of the folding apparatus, the batcher 600. The batcher 600 is an essentially elongated rectangular confinement which is adapted to accept the air knife—advanced web 311 into its interior. The batcher is the second piece of apparatus devised expressly by the instant inventors for the purposes of realizing a uniquely constructed product. It should be readily understood by the reader, indeed those of ordinary skill in the art, that with the folded array adequately gathered into the batcher, there is little left to accomplish save acquiring the final cure to the partially cured adhesive strips to form bond lines. The point at which the pleated fabric enters the batcher 600 in the collapsed state signals accretion (uniting by adhesion) of the desired product and the end of the algorithmic manufacturing process. Depending upon the types of adhesive used, it is conceivable that collection in the batcher could signal termination of the entire process.

The creaser 400 is illustrated in a partially sectional side elevation at FIG. 6 as having two roller assemblies 402. Passing therebetween is the web 311, having been properly tensioned so that pleats may be made in proper registration with the bond striping. One roller assembly 402, here the left-hand assembly partially shown, is rigidly mounted by the bolting 404 of its pillow block bearing 406 to the slider block 408 that is rigidly mounted to the pleater pad 410. The second roller, of FIG. 6, the right-hand assembly illustrated, is similarly bolt-mounted 404 to the fixed bearing pillow block 406. Unlike the first assembly, however, the second roller assembly is bolted to an adjustable slider block 408′. The adjustability of slider block 408′ derives from the fact that the bolt holes 405 for this assembly are over-sized and allow adjustment mechanism 412 to exert a force on the slider block 408′ to adjust the center spacing between the two cylindrical roller assemblies 402. An air pressure supply line 414 is seen entering the roller assembly at the pillow block central thereto and axial of the roller assembly 415. The last outwardly visible elements of the roller assembly are the crease ridges 416. The crease ridges are essentially inverted “V” shaped protrusions which run the length of the roller and are bolted or riveted 418 to the outer periphery of the roller assembly 402.

In the cut-away portion of FIG. 6, disposed on the right hand pleater roller subassembly 406 is a tri-part, concentric, cylinder roller structure. Moving from the axial center outward, the structure includes a first or inner rigid, foraminous cylinder that is rigidly fixed to the cylinder end plate 423 and rotatable therewith on the cylinder bearing. Next, an intermediate cylinder includes a bladder likewise sealed to the cylinder end plates 423 in spaced-apart registry from the foraminous inner cylinder. It rotates with the inner foraminous cylinder. One will now recognize the cooperative relationship between the air pressure supply 414 passing through the sealed bearings 415 into the perforated chamber formed by inner cylinder 420 and bounded sealably by the second cylinder (bladder) 422 as effecting an air-controllable cylindrical surface that may be caused to expand and contract, thereby effecting a slight change in diameter of outer cylinder 424, which adjusts the crease pitch relative to the bond lines. The outermost cylinder 424 comprises a resilient shell in contact registry with the intermediate cylinder 422, but not attached to the rotating cylinder end plate 423 that couples inner cylinder 420 with bladder cylinder 422. The outer cylinder is composed of a resilient material responsive to the flexing of intermediate cylinder 422, but formed of such a material that it will remain inactive and nonadhesive to the partially cured bonding material which it will contact, such as silicone rubber.

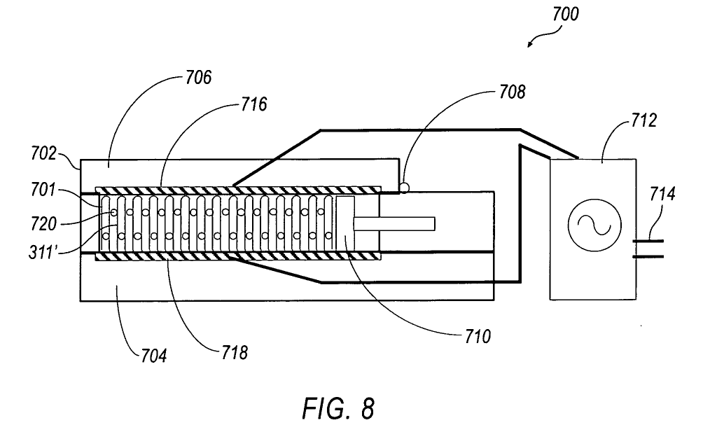

Final to this illustration is the apparatus which effects not only the fixing of the crease ridges 416 to the outer cylinder 424, but also couples the outer cylinder to the foraminous inner cylinder 420. The crease ridge includes rivets 418 and a torque coupling pin 426. The rivets pass through the outer flanges of the crease ridges 416 as shown in FIG. 8 and down through the outer and intermediate cylinders. Captured therebetween is the cap 427 of torque coupling pin 426. The torque coupling pin is freely slidable in selected foramens 421 of the inner cylinder 420. Cap 427 provides a seal that prevents air leakage from bladder cylinder 422. Thus, the coupling pin assembly couples the rotation of inner cylinder 420 to the outer cylinder 424 and, because of its slidability in foramen 421, allows the expansion and contraction of the outermost cylinder 424 as the intermediate cylinder-bladder 422 is caused to flex by the introduction or evacuation of air through supply line 414. If the phasing or pitch of creases between adhesive strips is improper, air is forced into or evacuated from bladder 422 causing it to expand or contract, thus adjusting to the proper crease pitch and phase (registry).

In the pleating operation, the web 311 to be pleated is introduced between the rollers which are moving in the direction indicated by the barbed arrows. As the properly phased crease ridge 416 comes in contact with the web 311, it nips it between its crest and the opposing roller, which at that space on its surface is devoid of ridging. The crease ridge 416 presses the web 311 into the resilient surface of the roller, thus effecting the crease in the web 311; and the creased web 311′ exits between the pleater rollers. Immediately thereafter, as generally described above, the creased web 311′ enters the folding station air knife subassembly 500.

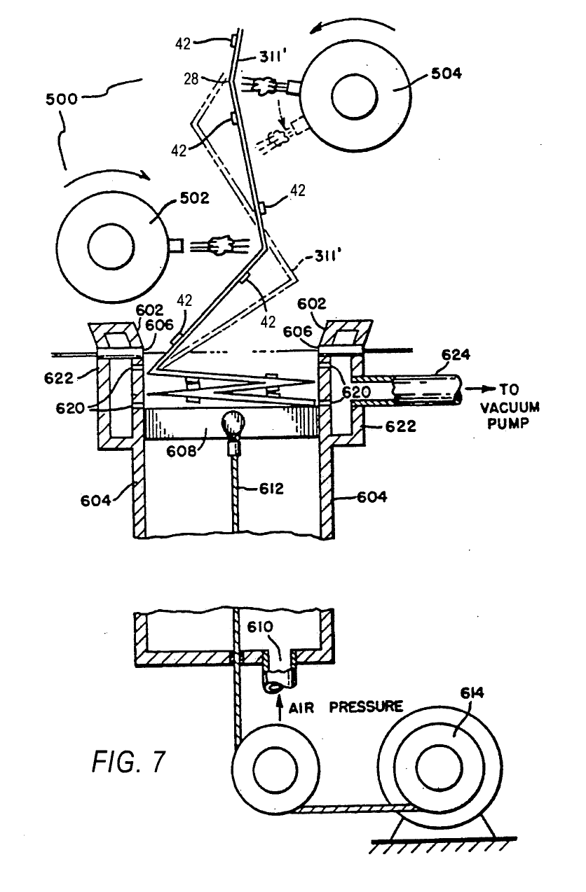

In a schematic drawing of greater detail, FIG. 7 portrays the subsequent operations performed on the creased web 311′ that has been adhesive coated to acquire the predetermined array configuration. As the creased fabric enters the air knife subassembly 500, the first rotating knife 504 exerts its continuous stream of air downwardly, enhancing the crease 116 and, rotating counter-clockwise, the first air knife 504, in conjunction with the second air knife 502 rotating clockwise, urges the fabric, while effecting a more pronounced fold, toward batcher box subassembly 600. When the air knives 502, 504 are in proper phase relationship, they will effect a continuous folding and urging of the creased web 311′ toward the mouth 602 of batcher subassembly 600.

The mouth receiving portions 602 of batcher box 604 are splayed with a smooth radius so as to receive and guide the now folding web 311′ smoothly into the interior of box 604. Located proximate the periphery of the box 604 proper is an electronic fold sensing network that detects the crest of every pleat passed into the mouth of the box 604. Sensed data are transmitted to the batcher box fill control (not shown herein). This assures that proper stacking takes place as the web 311′ is folded into the batcher box 604 by the action of the air knife subassembly 500.

As the folded web 311′ enters the batcher box, it encounters first the air pressure motivated base 608. Also proximate the sensor 606 is a series of peripheral ports 620 which, connected through peripheral chambers 622, draw off air which has accumulated at the mouth 602 of the batcher box 604. The air overpressure is drawn off through conduit 624. Concurrently, as air pressure is being supplied through air supply line 610, thus urging base 608 outward, data being sensed at sensor 606 (through suitable control means not shown herein) cause the actuation of stepping motor 614 to draw up cable 612, thus retracting base 608. Thus, as the count of folds is increased at the electronic sensor 606, the pressure supported base 608 is drawn toward the bottom of the batcher box 604, and the ensuing stack of pleated fabric is accomplished orderly and precisely. It can be seen in FIG. 7 that adhesive strips actually adhere to adhesive strips to form bonding lines. This may not always be the case and partially cured adhesive or bonding material may be placed in contact with portions of the web 311 not bearing adhesive.

The method of locally bonding the cellular array 20 includes the application of adhesives sensitive to excitation and self-heating or curing under the influence of radio-frequency electromagnetic fields. Further, the selection of a radio frequency, the selection of an adhesive or its components in consideration of the frequency, the apparatus 700 of FIG. 8, the method of application of the radio frequency to the product and the resulting product, itself will be described.

The adhesive is chosen to be thermally curable and to include compounds such as polyester monomers, metal salts, or nylon that readily absorb energy from a radio-frequency field. The frequency is chosen such that the material 40 of the web 311 has significantly less energy absorption than the adhesive.

FIG. 8 is a sectional schematic of the curing apparatus 700. The collected stack 701, in its partially cured stage, has been removed from batcher box 604 and placed into press 702. The press 702 is as long and as wide as required by the folded web 311′ and the pleat width, respectively. The press 702 includes a base 704 and a lid 706 interconnected at a hinge or hinges 708. A compression ram 710 is disposed at one end of the stack to assure alignment of all pleats and to apply pressure to the stack and its adhesive lines. The stack 701 is placed in the press 702 and compressed therein by a compression ram 710. Immediately after emplacement, the lid 706 is closed. A securing mechanism (not shown) firmly secures lid 706 to the base 704. Thereafter, a radio-frequency field is energized by a generator 712, powered by an electrical input 714. Application of the resulting radio-frequency electric field by voltages on the conductive electrode platens 716, 718 of the curing apparatus 700 heats the adhesive 720 (bonding line 24 of FIGS. 1 and 2) to trigger its activation and curing, thereby bonding adjacent layers wherever adhesive lines are present between them.

In an exemplary apparatus 700, the generator 712 is a 25 KW power supply that operates at 17 MHz (ideal for coupling to the adhesive is 27.12 MHz, but field efficiency and stability is enhanced at lower frequencies, and coupling is still adequate). The temperatures of upper electrode 715 and lower electrode 718 are controlled by chilled and heated water to a constant temperature of 65 degrees Fahrenheit. The temperature is raised and lowered with changes in ambient temperature. The power and frequency are continually adjusted to compensate for load changes during curing. The compression ram 710 and the upper electrode 716 pressure is deliverable pneumatically in two stages between 20 and 50 pounds per square inch (PSI).

In one exemplary process, the pre-folded stack 701 is conveyed into the press 702 and onto the lower electrode 718. The upper electrode 716 is lowered to a predetermined height in contact with the stack 701. A portion of the stack 701 is compressed by the pneumatic ram 710, at which time the RF field is activated at 3.5 amps to preheat the adhesive 720 without forcing the stack 701 out of stacked alignment. After a predetermined time, the adhesive 720 is softened, the stack 701 is substantially compressed, and the RF field is reduced to 2.75 amps to complete the bonding. After a second predetermined period of time, the RF field is terminated and the stack 701 remains under pressure for an additional predetermined cooling period to cool in position, setting the bonds. After the cooling cycle the upper electrode 716 in the lid 706 is raised and the stack 701 is removed from the press 702.

One benefit in the above described process is the application to multiple linear adhesive features that are neither ‘parallel’ (i.e, reaching from one electrode to the other) nor ‘perpendicular’ (i.e., presenting a broad flat target normal to the field). In some instances, called ‘stray field’ heating, the glue to be heated cannot be arranged either perpendicularly or parallel. In the described process, however, the adjacent substrate material is not RF-conductive and so experiences little absorption of the RF energy from stray field. The material 40 may be formed from woven fabric, non-woven fabric, polyester, or the like. The described process relies on the uniform placement of discontinuous absorbent zones (adhesive lines 720) to produce uniform absorption and heating of those zones. Otherwise, the field stability and heating uniformity becomes unsustainable.

Another benefit of the described process is the adaptation of an RF press 702 to a flexible substrate. The RF heating of a complex, flexible product is unique and offers advantages over the prior art.

As will be clear to one skilled in the art, the described embodiments and methods, though having the particular advantages of compactness and convenience, are not the only methods or arrangements contemplated. Some exemplary variants include: a) material to be treated and bonded can be fed through the RF field in a continuous stream, rather than by batches; b) material blocks to be bonded can be fed through a smaller field area, curing from one end to the other sequentially, rather than the whole block at once; and c) any combination of frequencies and materials receptive thereto could be substituted for the chosen RF and adhesives.

The precise application of activation energy to the adhesive rather than the bulk stack of material has many advantages including: a) reduced total energy usage; b) reduced cycle time without waiting for heating and cooling the bulk material or containments; c) reduced handling of goods by in-line treatment rather than large oven-run batches; d) reduced thermal distortions and discolorations due to uneven heating of stack materials; e) precise and uniform heating of adhesive to assure uniform and complete bonding of adjacent layers without bleed-through to farther layers; f) usability with stack materials that are not amenable to thermal or other adhesive curing cycles in bulk; and g) improved regularity of pleat alignment and glue line positioning by reduced clamping and thermal loads during cure.

The preceding description has been presented only to illustrate and describe exemplary embodiments of the methods and systems of the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope. The scope of the invention is limited solely by the following claims.

What is claimed is:

1. A treatment method comprising:
providing a flexible substrate;
placing a material to be treated on a surface of said flexible substrate; and
treating said material with a frequency energy.

2. The treatment method of claim 1, wherein said substrate is a multi-layer array.

3. The treatment method of claim 1, wherein said substrate is formed from fabric or polyester.

4. The treatment method of claim 1, wherein said substrate is a pre-folded multi array having a first surface and a second surface, said first surface being proximate said second surface.

5. The treatment method of claim 4, wherein said step of placing includes having said material disposed between said first surface and said second surface of said flexible substrate.

6. The treatment method of claim 1, further including compressing said pre-folded multi-array.

7. The treatment method of claim 1, wherein said material is an adhesive.

8. The treatment method of claim 7, wherein said adhesive is sensitive to excitation or curing.

9. The treatment method of claim 7, wherein said adhesive is thermally curable and includes a polyester monomer or a metal salt.

10. The treatment method of claim 1, wherein said frequency energy is provided by a radio-frequency.

11. The treatment method of claim 1, including providing having at least one electrode to supply said frequency energy.

12. The treatment method of claim 1, wherein a temperature resulting from said frequency energy is selectively controlled.

13. The treatment method of claim 12, wherein said temperature is controlled by selectively adjusting a radio-frequency field.

14. The treatment method of claim 12, wherein said temperature is controlled by a heated liquid or a cooled liquid.

15. The treatment method of claim 1, further including reducing a frequency field for a predetermined time.

16. A treatment method comprising:
providing a flexible multi-layer array, said array having a first surface and a second surface, said first surface being proximate said second surface;
placing a bonding material between said first surface and said second surface;
generating a frequency field by energizing an electrode for selectively providing a radio-frequency energy;
treating said bonding material with said radio-frequency energy for a first predetermined period of time; and
selectively controlling a temperature provided by said radio-frequency energy.

17. The treatment method of claim 16, further including reducing said frequency field for a second predetermined period of time.

18. The treatment method of claim 16, further including compressing said array before or after said generating said frequency filed.

19. The treatment method of claim 16, wherein said array is formed from a woven or non-woven fabric.

20. The treatment method of claim 16, wherein said bonding material is sensitive to excitation or curing.

21. The treatment method of claim 16, wherein said bonding material is thermally curable and includes one of a polyester monomer and a metal salt.

22. A treatment method comprising:
providing a flexible multi-layer array formed from a fabric or polyester, said array having a first surface and a second surface, said first surface being proximate said second surface;
placing a bonding material between said first surface and said second surface, said bonding material being thermally curable;
compressing said array;
generating a frequency field by energizing an electrode for selectively providing a radio-frequency energy;
treating said bonding material with said radio-frequency energy for a first predetermined period of time;
selectively controlling a temperature provided by said radio-frequency energy;
reducing said frequency field for a second predetermined period of time.

23. The treatment method of claim 23, wherein said temperature is controlled by selectively adjusting said radio-frequency field.

24. The treatment method of claim 23, wherein said temperature is controlled by a heated liquid or a cooled liquid.
